(19) United States
(12) Patent Application Publication
(10) Pub. No.: US 2026/0010470 A1
(43) Pub. Date: Jan. 8, 2026

(54) MEMORY SYSTEM AND METHOD

(71) Applicant: Kioxia Corporation, Tokyo (JP)

(72) Inventor: Mitsunori TADOKORO, Fujisawa (JP)

(73) Assignee: Kioxia Corporation, Tokyo (JP)

(21) Appl. No.: 19/074,713

(22) Filed: Mar. 10, 2025

(30) Foreign Application Priority Data
Jul. 2, 2024 (JP) 2024-106645

(51) Int. Cl. G06F 12/02

(52) U.S. Cl. CPC G06F 12/0246

(57) ABSTRACT

A memory system includes a non-volatile memory including one memory die; and a controller coupled to the non-volatile memory and a host including a plurality of submission queues. The controller includes a first command queue corresponding to the memory die and a second command queue corresponding to the memory die. The controller is configured to: retrieve a first command from a first one of the submission queues; determine whether a second command retrieved from the first submission queue before the first command is retrieved is stored in the second command queue; when the second command is stored in the second command queue, store the first command retrieved from the first submission queue in the first command queue; and when the second command is not stored in the second command queue, store the first command retrieved from the first submission queue in the second command queue.

### CROSS-REFERENCE TO RELATED APPLICATION

This application is based upon and claims the benefit of priority from Japanese Patent Application No. 2024-106645, filed Jul. 2, 2024, the entire contents of which are incorporated herein by reference.

### FIELD

Embodiments described herein relate generally to a memory system and a method of controlling a non-volatile memory.

### BACKGROUND

A memory system incorporating a non-volatile memory achieves high performance by driving a plurality of memory dies in the non-volatile memory in parallel. The memory system distributes commands issued by a host and stored in a submission queue (SQ) to a plurality of memory dies that can be driven in parallel. A plurality of SQs may be provided in the host.

In such a memory system, it is necessary to efficiently distribute the commands stored in the plurality of SQs to the plurality of memory dies.

### DESCRIPTION OF THE DRAWINGS

FIG. 1 is a diagram illustrating an example of a configuration of an information processing system including a memory system according to an embodiment and a host connected to the memory system.

FIG. 2 is a diagram illustrating an example of a die queue state table of the memory system according to the embodiment.

FIGS. 3A and 3B are diagrams illustrating a first comparative example.

FIGS. 4A and 4B are diagrams (first diagrams) illustrating a second comparative example.

FIGS. 5A to 5D are diagrams (second diagrams) illustrating the second comparative example.

FIGS. 6A to 6D are diagrams illustrating a third comparative example.

FIG. 7 is a diagram illustrating an outline of queue management of commands by a first NAND die queue and a second NAND die queue of the memory system according to the embodiment.

FIG. 8 is a diagram illustrating details of the queue management of commands by the first NAND die queue and the second NAND die queue of the memory system according to the embodiment.

FIG. 9 is a diagram illustrating an example of processing in which a controller searches for a command from the first NAND die queue in the memory system according to the embodiment.

FIGS. 10A to 10I are diagrams illustrating an example of a procedure in which the controller stores a command in the first NAND die queue and the second NAND die queue in the memory system according to the embodiment.

FIG. 11 is a flowchart illustrating a flow of processing when the controller retrieves a command from a submission queue (SQ) in the memory system according to the embodiment.

FIG. 12 is a flowchart illustrating a flow of processing when the controller retrieves a command from the second NAND die queue in the memory system according to the embodiment.

FIG. 13 is a flowchart illustrating a flow of processing in which the controller searches for a command from the first NAND die queue in the memory system according to the embodiment.

FIG. 14 is a diagram illustrating an example of an implementation of the first NAND die queue and the second NAND die queue in the memory system according to the embodiment.

FIGS. 15A to 15C are diagrams illustrating an example of search of a first NAND die queue in a memory system according to a first modification example of the embodiment.

FIG. 16 is a diagram illustrating an example in which a plurality of second NAND die queues are provided in a memory system according to a second modification example of the embodiment.

FIG. 17 is a diagram illustrating queue management of commands using a plurality of second NAND die queues in the memory system according to the second modification example of the embodiment.

### DETAILED DESCRIPTION

Embodiments provide a memory system capable of efficiently performing queue management of commands.

In general, according to one embodiment, a memory system comprises a non-volatile memory including at least one memory die; and a controller including a first command queue corresponding to the at least one memory die and a second command queue corresponding to the at least one memory die. The controller is operatively coupled to the non-volatile memory and a host that includes a plurality of submission queues. Each of the plurality of submission queues is configured to store a plurality of commands. The controller is configured to: retrieve a first command from a first submission queue of the plurality of submission queues; determine whether a second command retrieved from the first submission queue before the first command is retrieved is stored in the second command queue; when the second command is stored in the second command queue, store the first command retrieved from the first submission queue in the first command queue; and when the second command is not stored in the second command queue, store the first command retrieved from the first submission queue in the second command queue.

Hereinafter, embodiments will be described with reference to the drawings.

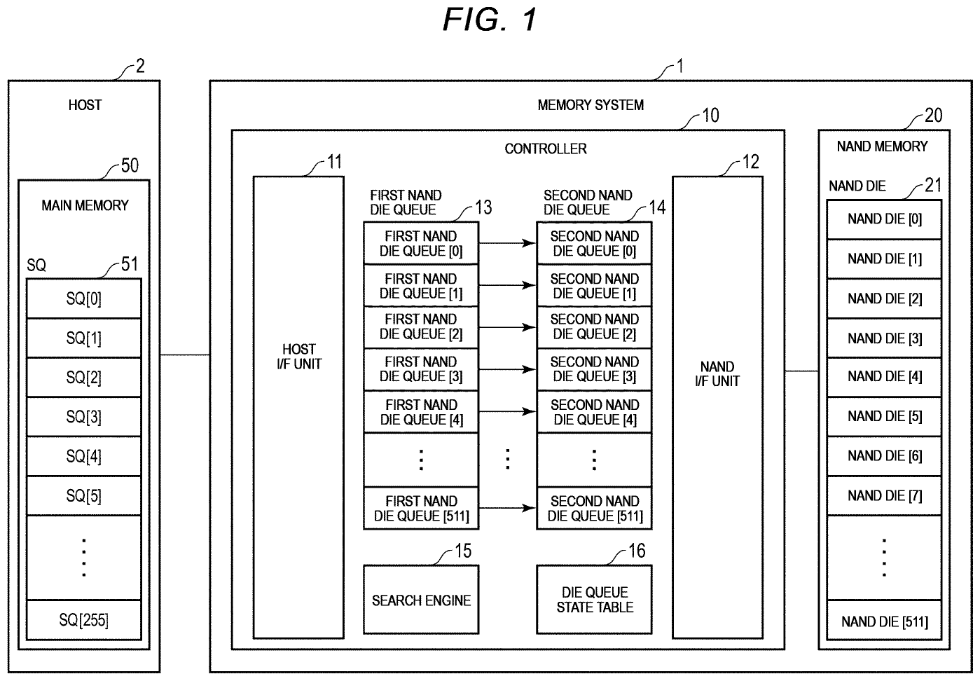

FIG. 1 is a diagram illustrating an example of a configuration of an information processing system including a memory system 1 according to an embodiment and a host 2 connected to the memory system 1.

The memory system 1 is a storage device. Here, an example in which the memory system 1 is implemented as a solid state drive (SSD) is shown.

The host 2 is an information processing apparatus such as a server or a personal computer. The memory system 1 and the host 2 are connected by an interface that complies with, for example, the PCI Express™ (PCIe™) standard. In addition, the memory system 1 and the host 2 communicate with each other according to a protocol that complies with, for example, the NVM Express™ (NVMe™) standard.

The host 2 includes a main memory 50. The main memory 50 is, for example, a dynamic random access memory (DRAM). The host 2 provides the main memory 50 with a submission queue (SQ) 51 for storing a command for the memory system 1. Here, an example is shown in which 256 SQs 51 (SQs [0-255]) are provided in the main memory 50. The host 2 uses a plurality of SQs 51, for example, for each program.

In the information processing system according to the embodiment, the command issued by the host 2 to the memory system 1 and stored in the SQ 51 is an NVMe command that complies with the NVMe standard. When the host 2 stores the NVMe command in the SQ 51, the host 2 transmits a PCIe packet that complies with the PCIe standard to the memory system 1 in order to notify the memory system 1 of the issuance of the NVMe command. The host 2 can notify the memory system 1 of issuance of a plurality of NVMe commands with one PCIe packet.

The memory system 1 includes a controller 10 and a non-volatile memory 20. The controller 10 and the non-volatile memory 20 are electrically connected to each other by a signal line. The controller 10 is configured with, for example, a system-on-a-chip (SoC). The functions of each part of the controller 10 can be implemented by dedicated hardware, a processor that executes a program, or a combination thereof.

The controller 10 executes a write operation of data received from the host 2 to the non-volatile memory 20, a read operation of data requested by the host 2 from the non-volatile memory 20, and the like, based on a command issued by the host 2.

When the PCIe packet for notifying the issuance of the NVMe command is received from the host 2, the controller 10 transmits, to the host 2, a PCIe packet for retrieving the NVMe command from the SQ 51. In response to this PCIe packet, the host 2 transmits the NVMe command in the SQ 51 to the memory system 1. The controller 10 can retrieve a plurality of NVMe commands from the SQ 51 in one PCIe packet.

The non-volatile memory 20 is, for example, a NAND flash memory. The non-volatile memory 20 includes a plurality of memory dies 21. Hereinafter, the non-volatile memory 20 is also referred to as a NAND memory 20. In addition, the memory die 21 is also referred to as a NAND die 21, a memory chip 21, or a NAND chip 21. Here, an example is shown in which 512 NAND dies 21 (NAND dies [0-511]) are provided in the NAND memory 20.

The controller 10 includes a host interface (I/F) unit 11, a NAND interface (I/F) unit 12, a first NAND die queue 13 (first NAND die queues [0-511]) and a second NAND die queue 14 (second NAND die queues [0-511]) each having the same number as the NAND dies 21, a search engine 15, and a die queue state table 16. The first NAND die queue 13, the second NAND die queue 14, and the die queue state table 16 are provided in, for example, a static random access memory (SRAM) that is built in the controller 10.

The host interface unit 11 controls communication with the host 2. The NAND interface unit 12 controls the writing of data to the NAND die 21 in the NAND memory 20 and the reading of data from the NAND die 21.

The first NAND die queue 13 is a command queue that stores the command retrieved from the SQ 51. When a command is retrieved from the SQ 51, the controller 10 specifies the NAND die 21 that is a target of the command. The controller 10 specifies the NAND die 21 that is a target of the command, for example by converting a logical address of access target data, which is specified by the command retrieved from the SQ 51, into a physical address of the NAND memory 20. The controller 10 stores the retrieved command in the first NAND die queue 13, which basically corresponds to the specified NAND die 21. That is, the controller 10 distributes the command issued by the host 2 to the memory system 1 to a plurality of first NAND die queues 13.

When access target data which is specified by a command, is across a plurality of NAND dies 21, the controller 10 may divide the command into subcommands for each NAND die 21 and store the subcommands in the first NAND die queue 13 corresponding to the NAND die 21 which is a target of each subcommand. Alternatively, the controller 10 may store the command in a first NAND die queue 13 corresponding to the NAND die 21 to be first accessed in response to the command, and after the access to the target NAND die 21 is started, the controller 10 may re-store the command in another first NAND die queue 13 corresponding to the NAND die 21 to be next accessed in response to the command.

The controller 10 stores the retrieved command in the second NAND die queue 14 instead of the first NAND die queue 13 in a specific situation. This point will be described later.

A plurality of commands retrieved from a plurality of different SQs 51 may be mixed in one first NAND die queue 13. Among the plurality of commands stored in the first NAND die queue 13, the controller 10 is configured to retrieve not only a command at the head or end but also a command in a middle of the first NAND die queue 13.

The second NAND die queue 14 is a command queue that stores a command retrieved from the first NAND die queue 13 or the SQ 51. The processing of moving a command from the first NAND die queue 13 to the second NAND die queue 14 will be described later. The controller 10 controls access to the NAND die 21 based on the command stored in the second NAND die queue 14 instead of the first NAND die queue 13. That is, the controller 10 controls a data write operation and a data read operation to the NAND die 21 based on the command retrieved from the second NAND die queue 14.

The search engine 15 searches the first NAND die queue 13 for a command that matches a given search condition.

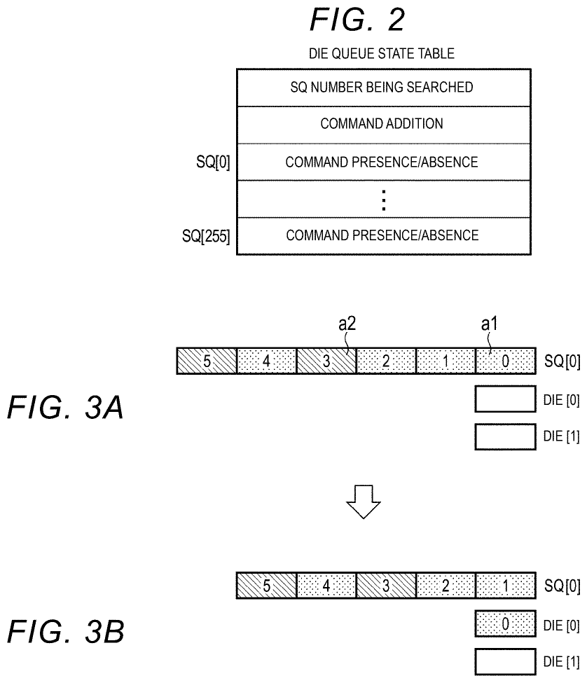

FIG. 2 is a diagram illustrating an example of the die queue state table 16. The die queue state table 16 records information for managing states of the corresponding first NAND die queue 13 and the second NAND die queue 14 for each NAND die 21. Specifically, the die queue state table 16 records the SQ number being searched, a command addition flag, and a command presence/absence flag corresponding to each SQ 51.

The SQ number being searched is information indicating an SQ 51 to be searched, when the search engine 15 is searching for a command to be moved from the first NAND die queue 13 to the second NAND die queue 14.

The command addition flag indicates whether a command belonging to the SQ 51 to be searched is added to the first NAND die queue 13 during searched by the search engine 15.

The command presence/absence flag corresponding to each SQ 51 indicates whether a command retrieved from each SQ 51 is to be stored in the first NAND die queue 13. In other words, the command presence/absence flag corresponding to each SQ 51 indicates whether a command of each SQ 51 is stored in at least one of the first NAND die queue 13 and the second NAND die queue 14. When one or more commands of a certain SQ 51 are stored in at least one of the first NAND die queue 13 and the second NAND die queue 14, a command retrieved from the certain SQ 51 is to be stored in the first NAND die queue 13. When any command of a certain SQ 51 is not stored in either the first NAND die queue 13 or the second NAND die queue 14, a command retrieved from the certain SQ 51 is to be stored in the second NAND die queue 14.

Here, a comparative example will be described. FIGS. 3A and 3B are diagrams illustrating a first comparative example.

In a memory system of the first comparative example, one NAND die queue is provided for each NAND die. In the first comparative example, each NAND die queue has one entry. The rectangle with the hatching of dots indicated by the reference numeral a1 is a command for the NAND die [0]. In addition, the rectangle with the hatching of oblique lines indicated by the reference numeral a2 is a command for the NAND die [1]. FIG. 3A illustrates an example in which commands are stored in the SQ [0] in the following order: a command 0, a command 1, and a command 2 for the NAND die [0], a command 3 for the NAND die [1], a command 4 for the NAND die [0], and a command 5 for the NAND die [1]. That is, the number inside the rectangle representing each command indicates the order in which the commands are stored in the SQ.

If the number of commands that each NAND die queue can store is small, there is an increased chance that a plurality of NAND dies cannot be driven in parallel. This problem is called a head of line blocking problem.

As illustrated in FIG. 3B, the command 0 at the head of SQ [0] is retrieved and stored in the NAND die queue [0], and then a command next at the head of the SQ [0] is the command 1. The command 1 is also a command for the NAND die [0] like the command 0. The NAND die queue [0] has only one entry. Therefore, the command 1 is not stored in the NAND die queue [0] until the command 0 is removed from the NAND die queue [0]. That is, the command 1 remains at the head of the SQ [0]. Therefore, at this time point, the command 3 for the NAND die [1] that is located behind the command 1 in the SQ [0] is not retrieved and stored in the NAND die queue [1]. As a result, the NAND die [0] and the NAND die [1] cannot be driven in parallel.

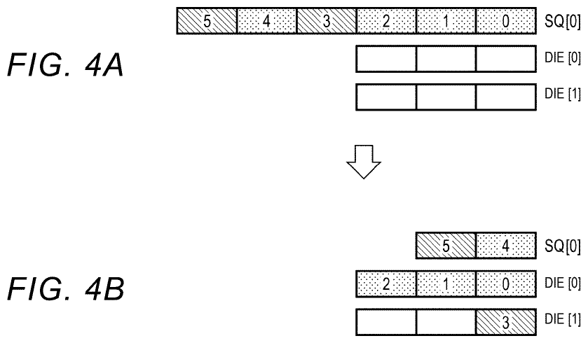

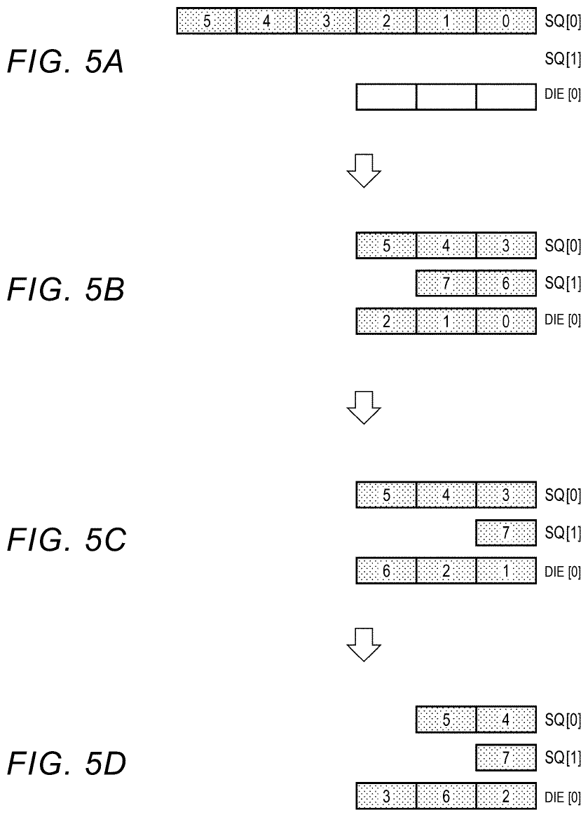

FIGS. 4A to 5D are diagrams: illustrating a second comparative example.

As illustrated in FIG. 4A, each NAND die queue of a memory system of the second comparative example has three entries. When the number of commands that each NAND die queue can store is large, there is an increased chance that a plurality of NAND dies can be driven in parallel. That is, the head of line blocking problem can be avoided.

As illustrated in FIG. 4B, the memory system of the second comparative example can retrieve the command 0, the command 1, and the command 2 from the SQ [0] and store the command 0, the command 1, and the command 2 in the NAND die queue [0], and can retrieve the command 3 from the SQ [0] and store the command 3 in the NAND die queue [1]. As a result, the NAND die [0] and the NAND die [1] can be driven in parallel.

However, when the number of entries in each NAND die queue is large, the processing start of commands of other SQs may be delayed. FIG. 5A illustrates an example in which the command 0, the command 1, the command 2, the command 3, the command 4, and the command 5 for the NAND die [0] are stored in the SQ [0].

In addition, FIG. 5B illustrates an example in which the command 0, the command 1, and the command 2 of the SQ [0] are retrieved and stored in the NAND die queue [0], and then a command 6 and a command 7 for the NAND die [0] are stored in the SQ [1]. In this case, since the command 1 and the command 2 of the SQ [0] are already stored in the NAND die queue [0], for example, the command 6 of the SQ [1] cannot be processed even after the command 0 of the SQ [0].

FIG. 5C illustrates an example in which, after the command 0 of the SQ [0] is processed, the command 6 of the SQ [1] is stored in the NAND die queue [0] behind the commands 1 and 2 of the SQ [0]. In addition, FIG. 5D illustrates an example in which, after the command 1 of the SQ [0] is processed, the command 2 of the SQ [0] becomes at the head of the NAND die queue [0], and the command 6 of the SQ [1] is still stored in the NAND die queue [0]. FIG. 5D also illustrates an example in which, by the round-robin arbitration, a command is retrieved from the SQ [0] (retrieval of the command 3) after a command is retrieved from the SQ [1] (retrieval of the command 6).

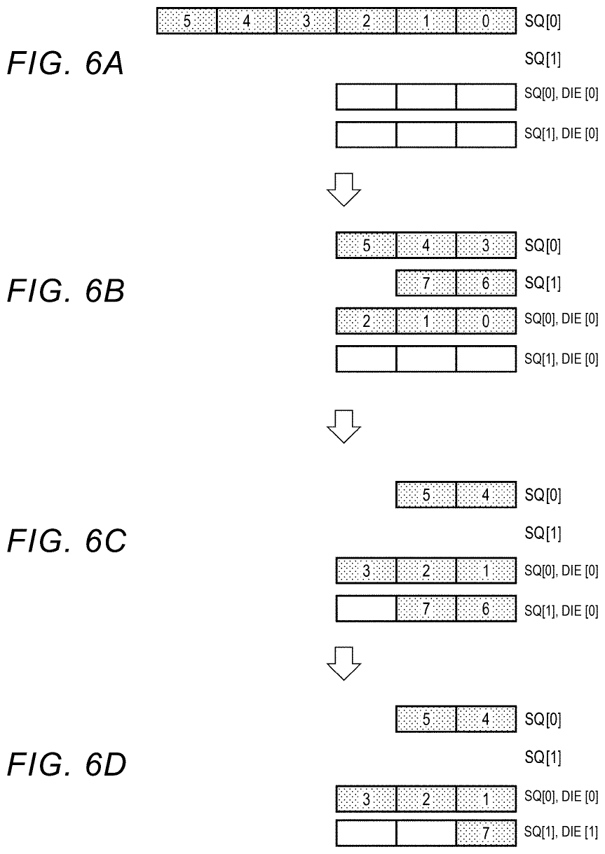

FIGS. 6A to 6D are diagrams illustrating a third comparative example.

In order to increase the chance for parallel driving of the NAND dies and to process a command (for example, the command 6 in FIGS. 5A to 5D) stored later in another SQ than a command (for example, the command 1 in FIGS. 5A to 5D) previously stored in a certain SQ, NAND die queues may be provided for each NAND die in the same number of SQs. In this case, arbitration is performed between the NAND die queues for each SQ to select a command to be processed.

FIG. 6A illustrates an example in which two NAND die queues for the SQ [0] and the SQ [1] are provided for the NAND die [0]. Each NAND die queue has three entries. FIG. 6A also illustrates an example in which the command 0, the command 1, the command 2, the command 3, the command 4, and the command 5 are stored in the SQ [0] for the NAND die [0].

In addition, FIG. 6B illustrates an example in which the command 0, the command 1, and the command 2 of the SQ [0] are retrieved and stored in the NAND die queue [0] for the SQ [0], and the command 6 and the command 7 for the NAND die [0] are stored in the SQ [1].

In a memory system of the third comparative example, NAND die queues are provided for each NAND die in the same number of SQs. Therefore, as illustrated in FIG. 6C, the command 6 and the command 7 of the SQ [1] can be stored in the NAND die queue [0] for the SQ [1]. FIG. 6C also illustrates an example in which the command 3 of the SQ [0] is stored in the NAND die queue [0] for the SQ [0] after the command 0 of the SQ [0] is processed.

In the memory system of the third comparative example, the command 6 and the command 7 can be stored in the NAND die queue [0] for the SQ [1] by providing NAND die queues in the same number of SQs. Therefore, as illustrated in FIG. 6D, in the third comparative example, the command 6 of the SQ [1] can be processed after the command 0 of the SQ [0] is processed and before the command 1 and the command 2 of the SQ [0] are processed.

However, in the case of the third comparative example, the number of NAND die queues required is the number of NAND dies multiplied by the number of SQs. That is, a large amount of memory is required for queue management of commands.

In the memory system 1 according to the embodiment, the first NAND die queue 13 and the second NAND die queue 14 are provided for each NAND die 21 instead of providing NAND die queues in the same number of SQs as in the third comparative example. As a result, the amount of memory required for queue management of commands is reduced.

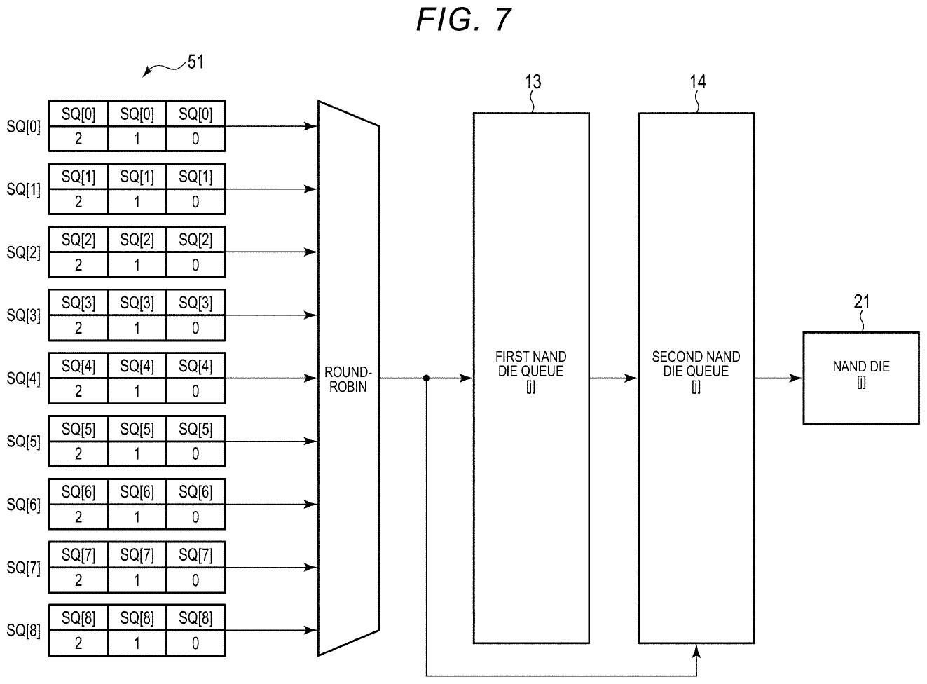

FIG. 7 is a diagram illustrating an outline of queue management of commands by the first NAND die queue 13 and the second NAND die queue 14 of the memory system 1 according to the embodiment.

FIG. 7 illustrates an example in which the host 2 provides nine SQs 51 (SQs [0-8]). FIG. 7 also illustrates a state in which three commands are stored in each of the SQs 51 for a certain NAND die 21 (NAND die [j]).

In such a circumstance, the memory system 1 of the embodiment manages the queue of commands stored in each SQ 51 by using only two die queues, the first NAND die queue 13 and the second NAND die queue 14, without having to provide NAND die queues for each NAND die 21 in the same number (nine in the example of FIG. 7) of SQs. In the memory system 1 according to the embodiment, the command stored in each SQ 51 is retrieved by, for example, round-robin arbitration, and is stored in the first NAND die queue 13 or the second NAND die queue 14. The controller 10 controls access to the NAND die 21 based on the command stored in the second NAND die queue 14.

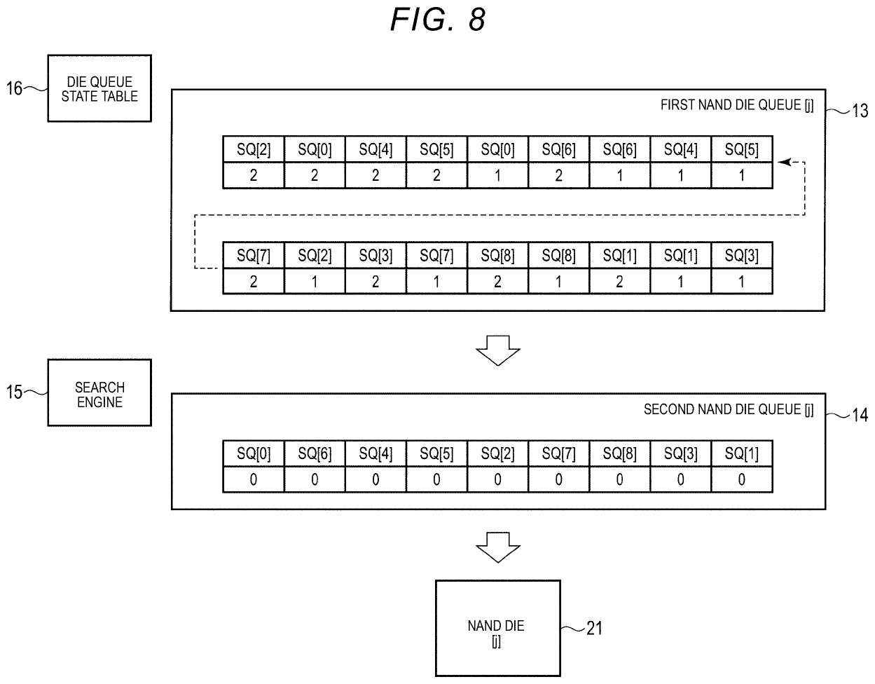

FIG. 8 is a diagram illustrating details of queue management of commands by the first NAND die queue 13 and the second NAND die queue 14 of the memory system 1 according to the embodiment. FIG. 8 illustrates a state in which, among commands targeting a certain NAND die 21 (NAND die [j]), a command at the head of each SQ 51 is stored in the second NAND die queue [j], and second and subsequent commands of the same SQ 51 are stored in the first NAND die queue [j].

Specifically, the second NAND die queue [j] stores a command 0 of each SQ 51 in the order of the SQ [1], the SQ [3], the SQ [8], the SQ [7], the SQ [2], the SQ [5], the SQ [4], the SQ [6], and the SQ [0]. The first NAND die queue 13 stores a command 1 of the SQ [3] at the head, a command 1 of the SQ [1], a command 2 of the SQ [1], a command 1 of the SQ [8], a command 2 of the SQ [8], a command 1 of the SQ [7], a command 2 of the SQ [3], a command 1 of the SQ [2], a command 2 of the SQ [7], a command 1 of the SQ [5], a command 1 of the SQ [4], a command 1 of the SQ [6], a command 2 of the SQ [6], a command 1 of the SQ [0], a command 2 of the SQ [5], a command 2 of the SQ [4], a command 2 of the SQ [0], and a command 2 of the SQ [2].

When acquiring a command for the NAND die [j] from an SQ 51 (SQ [i]) via the host interface unit 11, the controller 10 refers to the state of the SQ [i] in the die queue state table 16 to determine whether any command belonging to the sQ [i] is stored in either the first NAND die queue [j] or the second NAND die queue [j]. As described above, the die queue state table 16 records information for each NAND die 21 indicating whether a command belonging to each SQ 51 is stored in at least one of the first NAND die queue [j] and the second NAND die queue [j].

When any command belonging to the SQ [i] is not stored in either the first NAND die queue [j] or the second NAND die queue [j], the controller 10 stores the command acquired from the SQ [i] at the end of the second NAND die queue [j]. In this case, the controller 10 records information indicating that the command belonging to the SQ [i] is stored in the second NAND die queue [j] in the die queue state table 16 as a command presence/absence flag corresponding to the sQ [i].

On the other hand, when one or commands belonging to the SQ [i] are already stored in either the first NAND die queue [j] or the second NAND die queue [j], the controller 10 stores the command acquired from the SQ [i] at the end of the first NAND die queue [j].

As described above, the die queue state table 16 also records information indicating an SQ 51 that is being searched by the search engine 15 for a command to be moved from the first NAND die queue 13 to the second NAND die queue 14. When the search engine 15 is searching the SQ [i] to which a command to be acquired from the host 2 belongs, the controller 10 acquires the command and stores it at the end of the first NAND die queue 13. In this case, the controller 10 sets information indicating that the command belonging to the SQ [i], which is being searched, is added to the first NAND die queue 13 as a command addition flag in the die queue state table 16. The details of this case will be described later.

When a command is stored in the second NAND die queue [j] of a certain NAND die 21 (NAND die [j]), the controller 10 retrieves and processes the command stored at the head of the second NAND die queue [j]. More specifically, the controller 10 controls, via the NAND interface unit 12, the writing of data to the NAND die [j] or the reading of data from the NAND die [j], as requested by the retrieved command.

In parallel with the processing of the command retrieved from the head of the second NAND die queue [j], the controller 10 causes the search engine 15 to search the first NAND die queue [j] for the next command of the SQ [i] to which the command belongs. The search of the command by the search engine 15 is performed in the command storage order in the first NAND die queue [j] (i.e., in the order of acquiring the commands from the SQ 51). The search engine 15 sets one SQ [i] as a search key and searches one first NAND die queue [j] at a time. In the memory system 1 according to the embodiment, the search engine 15 stores a maximum of 512 search keys (SQ [i]) respectively in the 512 die queue state tables 16.

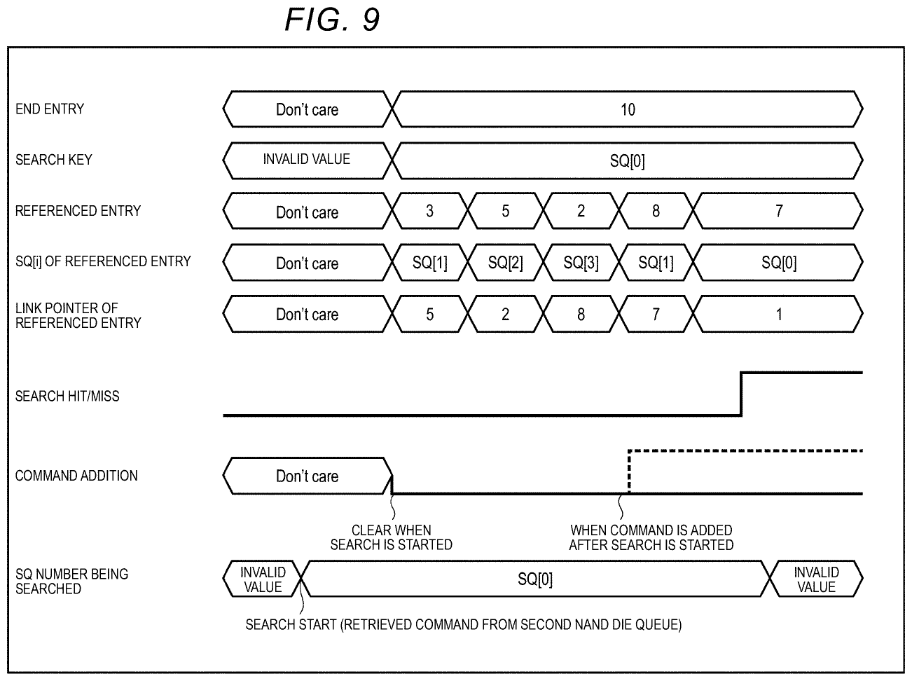

With reference to FIG. 9, an example of processing is described in which the search engine 15 searches the first NAND die queue 13 for the next command in an SQ 51 to which a command retrieved from the second NAND die queue 14 belongs. Here is an example in which the search engine 15 searches the first NAND die queue 13 for the next command of the SQ [0], as a command of the SQ [0] is retrieved from the second NAND die queue 14 for a certain NAND die 21. For the first NAND die queue 13, a storage location of a command at the head, a link pointer for tracing subsequent entries in the order in which commands are stored in the first NAND die queue 13, and a storage location of a command at the end, are managed.

When searching the first NAND die queue 13 for the next command of the SQ [0], the controller 10 sets the SQ [0] as the SQ number being searched, in the die queue state table 16. Further, the controller 10 clears the command addition flag of the die queue state table 16 when the search by the search engine 15 is started. That is, the controller 10 sets the flag to indicate that a command is not added during the search. When the search is started, the search engine 15 sets the storage location of the command at the end of the first NAND die queue 13 as a search end entry.

The search engine 15 first refers to the storage location (search start entry) in which the command at the head of the first NAND die queue 13 is stored. In the example illustrated in FIG. 9, the search start entry is an entry 3. Since the entry 3 stores a command of the SQ [1] (and thus search miss), the search engine 15 refers to an entry (entry 5) in which the subsequent command is stored. The entry 5 stores a command of the SQ [2] (and thus search miss). The search engine 15 refers to an entry 2 (the command of the SQ [3]) and an entry 8 (the command of the SQ [1]) in the same manner. The search engine 15 detects a command of the SQ [0] stored in an entry 7 (and thus search hit). Since the command of the SQ [0] is detected, the search engine 15 ends the search processing. In this case, the controller 10 records information indicating that the command belonging to the SQ [0] is stored in the first NAND die queue 13, in the die queue state table 16 as the command presence/absence flag corresponding to the SQ [0].

When a command of the SQ [0] is added to the first NAND die queue 13 during the search, the controller 10 records information indicating that the command of the SQ [0] is added, in the die queue state table 16 as the command addition flag.

When a command of the SQ [0] is not detected even when the search is performed up to the search end entry, the controller 10 checks the command addition flag recorded in the die queue state table 16.

When there is no added command, the controller 10 ends the search processing. In this case, the controller 10 records information indicating that a command belonging to the SQ [0] is not stored in the first NAND die queue 13 and the second NAND die queue 14, in the die queue state table 16 as the command presence/absence flag corresponding to the SQ [0].

When there is an added command, the controller 10 sets the storage location of a command at the end of the first NAND die queue 13 when the search is ended, as a new search end entry in the search engine 15. As a result, the search engine 15 resumes the search processing from the entry following the last-referenced entry.

The SQ number being searched, which is set in the die queue state table 16 when the search is started, is updated to information (invalid value) indicating that none of the commands of any SQ 51 is being searched when the search is ended, regardless of whether the command to be searched is detected.

When a plurality of commands of an SQ 51 to be searched are stored in the first NAND die queue 13, among the plurality of commands, the command first stored in the first NAND die queue 13 is detected.

As described above, when a command for a certain NAND die 21 (NAND die [j]) is acquired from a certain SQ 51 (SQ [i]), and information indicating that a command belongs to the SQ [i] is being searched is set in the NAND die queue state table 16, the controller 10 temporarily stores the command in the first NAND die queue [j]. The reason why the command is temporarily stored in the first NAND die queue [j] is that it is unknown whether a command belonging to the SQ [i], which is to be moved to the second NAND die queue [j], is already stored in the first NAND die queue [j].

When the command belonging to the SQ [i] is already stored in the first NAND die queue [j], the command already stored is detected by the search engine 15 and is retrieved by the controller 10 and stored in the second NAND die queue [j]. In this case, the command temporarily stored in the first NAND die queue [j] is kept stored in the first NAND die queue [j].

On the other hand, when no other command belonging to the SQ [i] is stored in the first NAND die queue [j], in a re-search of additional commands stored after the search starts, the command temporarily stored in the first NAND die queue [j] is detected by the search engine 15, retrieved by the controller 10, and stored in the second NAND die queue [j].

In this way, the controller 10 executes the queue management of commands, for each NAND die 21, such that a command at the head of each SQ [i] is stored in the second NAND die queue 14, and the second and subsequent commands of each SQ [i] are stored in the first NAND die queue 13.

As a result, the memory system 1 according to the embodiment can execute the queue management of command by using (A) NAND die queues in the number of twice the number of NAND dies, and (B) die queue state tables in the same number as the number of NAND dies, without requiring NAND die queues of the number of NAND dies multiplied by the number of SQs as in the third comparative example.

In addition, the controller 10 can perform a search of a command to be moved from the first NAND die queue 13 to the second NAND die queue 14 among all commands stored in the first NAND die queue 13 simultaneously with processing of a command retrieved from the second NAND die queue 14. In other words, the search time of the command can be covered up by the processing time of the command. Therefore, it is considered that the search of the command does not adversely affect the performance of the memory system 1.

As described above, the amount of memory required for the queue management of commands is reduced.

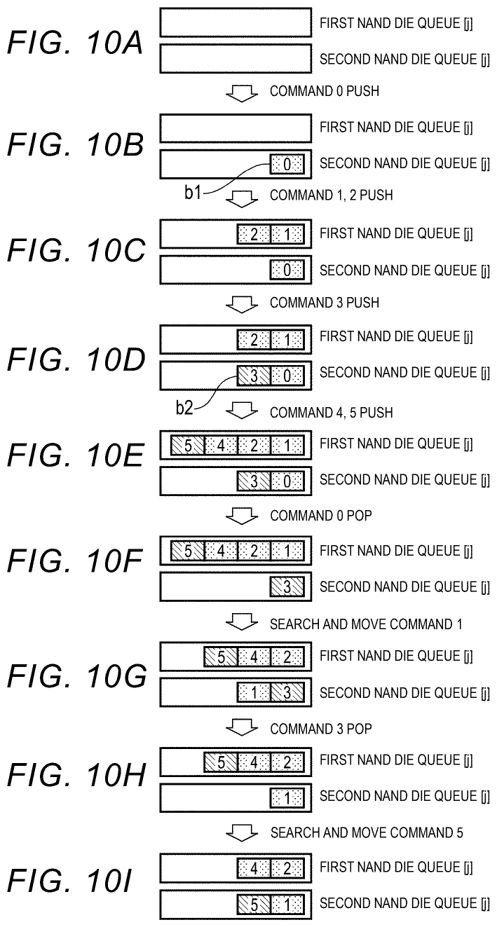

FIGS. 10A to 10I are diagrams illustrating an example of a procedure in which the controller 10 stores a command in the first NAND die queue 13 and the second NAND die queue 14 in the memory system 1 according to the embodiment.

The rectangle with the hatching of dots indicated by the reference numeral b1 is a certain command of an SQ 51 (referred to as SQ [X]). Further, the rectangle with the hatching of oblique lines indicated by the reference numeral b2 is a command of another SQ 51 (referred to as SQ [Y]). The numbers inside the rectangles representing commands indicate the issuance order of the commands.

FIG. 10A illustrates that the first NAND die queue 13 (first NAND die queue [j]) and the second NAND die queue 14 (second NAND die queue [j]) of a certain NAND die 21 (NAND die [j]) are both in an empty state in which no command is stored.

When the first NAND die queue [j] and the second NAND die queue [j] are in the state of FIG. 10A, and a command 0 for the NAND die [j] is retrieved from the SQ [X], the controller 10 stores the command 0 in the second NAND die queue [j] as illustrated in FIG. 10B. The command 0 is stored in the second NAND die queue [j] because the controller 10 can recognize that any command of the SQ [X] is not stored in the second NAND die queue [j] by using the die queue state table 16. Since the command 0 is stored in the second NAND die queue [j], the die queue state table 16 indicates that a command of the SQ [X] is stored in the second NAND die queue [j].

Subsequently, it is assumed that a command 1 and a command 2 are retrieved from the SQ [X]. At this time, since the command 0 of the SQ [X] is stored in the second NAND die queue [j], the controller 10 stores the command 1 and the command 2 in the first NAND die queue [j] as illustrated in FIG. 10C.

Next, it is assumed that a command 3 is retrieved from the SQ [Y]. When the controller 10 recognizes that any command of the SQ [Y] is not stored in the second NAND die queue [j] in the die queue state table 16, the controller 10 stores the command 3 in the second NAND die queue [j] as illustrated in FIG. 10D.

Subsequently, it is assumed that a command 4 of the SQ [X] and a command 5 of the SQ [Y] are retrieved. Since commands of the SQ [X] and the SQ [Y] are both stored in the second NAND die queue [j], the controller 10 stores the command 4 of the SQ [X] and the command 5 of the SQ [Y] in the first NAND die queue [j] as illustrated in FIG. 10E.

Here, it is assumed that the controller 10 retrieves the command 0 from the head of the second NAND die queue [j] this time. FIG. 10F illustrates a state after the command 0 is retrieved from the second NAND die queue [j]. Since the command 0 is a command of the SQ [X], the controller 10 searches for a command of the SQ [X] from the head of the first NAND die queue [j] by using the search engine 15. In this case, the command 1 of the SQ [X] is detected, and thus the controller 10 retrieves the command 1 from the first NAND die queue [j] and stores the command 1 in the second NAND die queue [j], as illustrated in FIG. 10G.

Note that, when any command of the SQ [X] is not detected, the controller 10 updates the die queue state table 16 to indicate that a command of the SQ [X] is not stored in the second NAND die queue [j].

Subsequently, the controller 10 retrieves the command 3 from the head of the second NAND die queue [j]. FIG. 10H illustrates a state after the command 3 is retrieved from the second NAND die queue [j]. Since the command 3 is a command of the SQ [Y], the controller 10 searches for a command of the SQ [Y] from the head of the first NAND die queue [j] by using the search engine 15. In this case, the command 5 of the SQ [Y] is detected, and thus the controller 10 retrieves the command 5 from the first NAND die queue [j] and stores the command 5 in the second NAND die queue [j], as illustrated in FIG. 10I.

In this way, for each NAND die 21, the controller 10 controls such that a command at the head of each SQ 51 (SQ [i]) is stored in the second NAND die queue [j], and thus the amount of memory required for the queue management of commands is reduced.

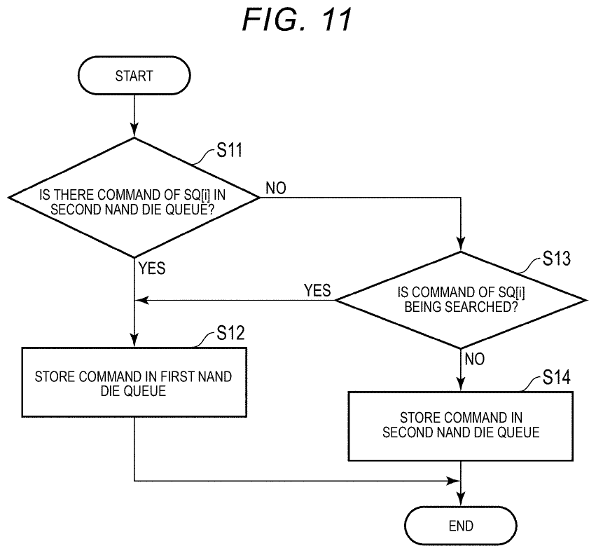

FIG. 11 is a flowchart illustrating a flow of processing when the controller 10 of the memory system 1 according to the embodiment retrieves a command from an SQ 51.

When the controller 10 retrieves a command from a certain SQ 51 (SQ [i]), the controller 10 determines whether any command of the SQ [i] is stored in the second NAND die queue 14 (S11). When any command of the SQ [i] is stored (S11: YES), the controller 10 stores the retrieved command in the first NAND die queue 13 (S12).

When any command of the SQ [i] is not stored in the second NAND die queue 14 (S11: NO), the controller 10 next determines whether the first NAND die queue 13 is being searched for a command of the SQ [i] (S13). When the first NAND die queue 13 is being searched (S13: YES), the controller 10 temporarily stores the retrieved command in the first NAND die queue 13 (S12).

When any command of the SQ [i] is not stored in the second NAND die queue 14 (S11: NO) and a command of the SQ [i] is not being searched (S13: NO), the controller 10 stores the retrieved command in the second NAND die queue 14 (S14).

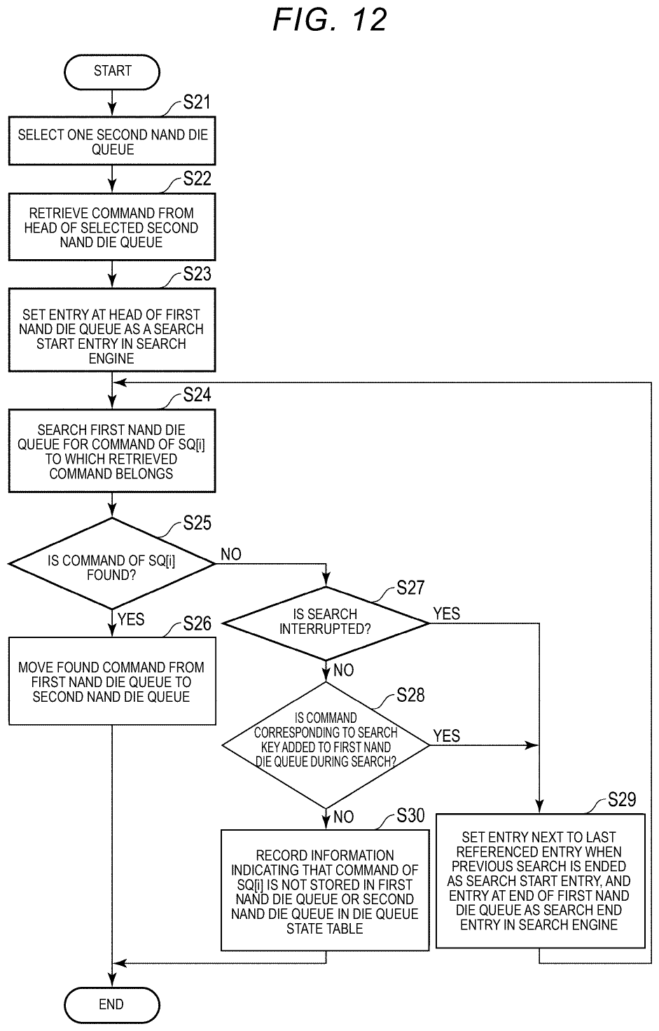

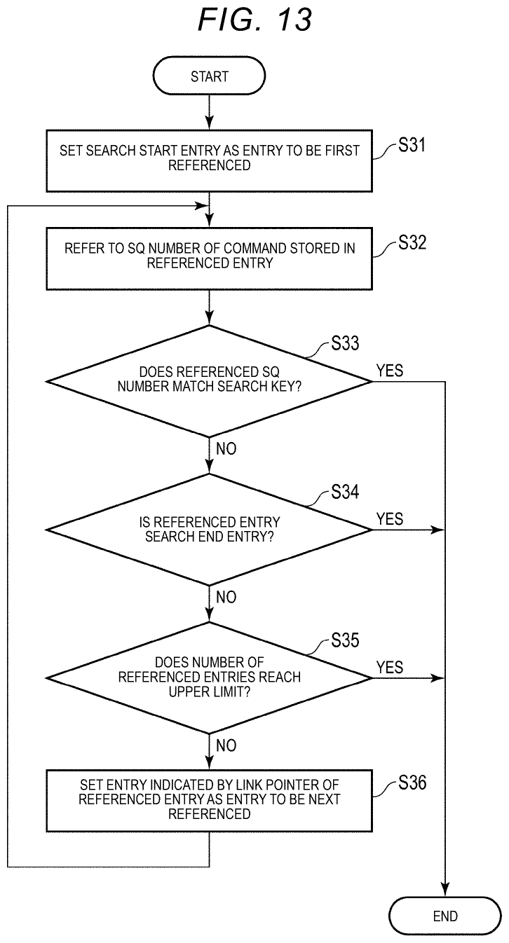

FIG. 12 is a flowchart illustrating a flow of processing in which the controller 10 of the memory system 1 according to the embodiment retrieves a command from the second NAND die queue 14 and determines whether a command to be moved to the second NAND die queue 14 is stored in the first NAND die queue 13. In this process, the controller 10 searches the first NAND die queue 13 by using the search engine 15. This process is performed for each NAND die 21. That is, in the present embodiment, the processing shown in the flowchart is performed in parallel. The maximum number of processing performed in parallel is equal to the number of NAND dies 21, and is 512 in the present embodiment. In addition, FIG. 13 is a flowchart illustrating a flow of processing in which the search engine 15 searches the first NAND die queue 13 for the next command of an SQ 51 to which the command retrieved from the second NAND die queue 14 belongs.

The controller 10 selects one of the plurality of second NAND die queues 14, for example, by the round-robin arbitration (S21). The controller 10 retrieves a command from the head of the selected second NAND die queue 14 (S22).

The controller 10 first sets the entry at the head of the first NAND die queue 13 as the search start entry in the search engine 15 (S23). The controller 10 searches the first NAND die queue 13 by using the search engine 15 for a command of an SQ 51 (SQ [i]) to which the retrieved command belongs (S24). At this time, the search end entry set in the search engine 15 is the entry at the end of the first NAND die queue 13.

The description will be moved to FIG. 13. The search engine 15 sets the search start entry as an entry to be first referenced (S31). The search engine 15 refers to the SQ 51 number to which a command stored in the referenced entry belongs (S32). The search engine 15 determines whether the referenced SQ 51 number (SQ number) matches a search key (S33). When the SQ number matches the search key (S33: YES), the search engine 15 ends the processing with a successful search (search hit).

When the SQ number does not match the search key (S33: NO), the search engine 15 determines whether the referenced entry is the search end entry (S34). When the referenced entry is the search end entry (S34: YES), the search engine 15 ends the processing with a search failure (search miss).

When the referenced entry is not the search end entry (S34: NO), the search engine 15 determines whether the number of the referenced entries reaches the upper limit (S35). When the number of the referenced entries reaches the upper limit (S35: YES), the search engine 15 ends the processing with a search interruption. An example of a case in which the upper limit is set for the number of entries to be referenced is described below.

When the number of the referenced entries does not reach the upper limit (S35: NO), the search engine 15 sets the entry indicated by the link pointer of the referenced entry as an entry to be next referenced (S36), and executes the processing from step S32.

Refer back to FIG. 12. The description of the processing after the controller 10 retrieves the command from the second NAND die queue 14 will be continued.

When a command of the SQ [i] is found (S25: YES), the controller 10 moves the found command from the first NAND die queue 13 to the second NAND die queue 14 (S26).

On the other hand, when a command of the sQ [i] is not found (S25: NO), the controller 10 determines whether the search is interrupted (S27). When the search is not interrupted (S27: NO), the controller 10 determines whether a command belonging to the SQ [i] being searched is added to the first NAND die queue 13 after the search is started by the search engine 15 (S28).

When the search is interrupted (S27: YES) or when the command is added (S28: YES), the controller 10 re-searches the first NAND die queue 13 including the command added during the search (S29). At that time, the search start entry set in the search engine 15 is a next entry (that is, an entry indicated by the link pointer) of the last-referenced entry when the previous search is ended. The search end entry set in the search engine 15 is an entry at the end of the first NAND die queue 13. A command of the SQ [i] detected by the re-search is, if any, for example, a command of the SQ [i] determined to be in the search in the processing of step S13 to step S12 described with reference to FIG. 11, and is temporarily stored in the first NAND die queue 13. The processing by the controller 10 transitions to step S24 (search processing by the search engine 15).

On the other hand, when a command is not added (S28: NO), the controller 10 records information indicating that a command of the SQ [i] is not stored in the first NAND die queue 13 or the second NAND die queue 14, in the die queue state table 16 (S30).

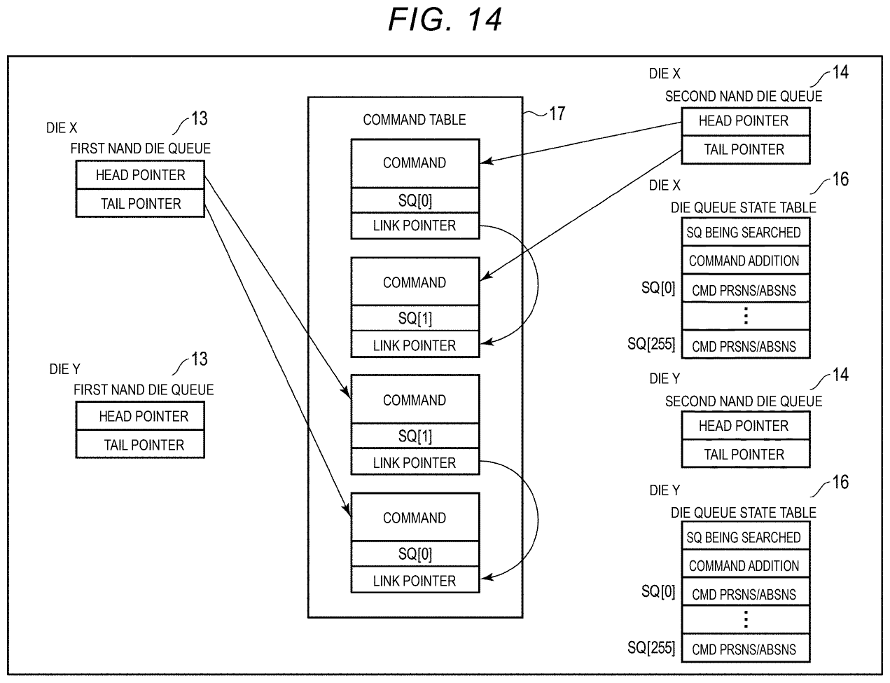

Next, an example of an implementation of the first NAND die queue 13 and the second NAND die queue 14 will be described with reference to FIG. 14.

The controller 10 of the memory system 1 according to the embodiment manages a command table 17 in which a command retrieved from an SQ 51 is stored. The command table 17 has a plurality of entries. Each entry stores a command (command body), information indicating the SQ 51 in which the command was stored, and a link pointer for tracking a subsequent entry. For example, the command table 17 is provided in an SRAM built in the controller 10. In this case, the link pointer is an address indicating a location in the SRAM in which the subsequent entry is stored.

Each of the 512 first NAND die queues 13 can be implemented with a head pointer indicating the location of an entry in which a command at the head of each first NAND die queue 13 is stored and a tail pointer indicating the location an the entry in which a command at the end is stored.

In the first NAND die queue 13 in an empty state, the head pointer and the tail pointer do not indicate valid entries in the command table 17. That is, the head pointer and the tail pointer are NULL pointers. When a new command is added to the first NAND die queue 13 in this state, the controller 10 first stores the new command and information (SQ number) for identifying the SQ 51 in which the command was stored, in an empty entry of the command table 17. The head pointer and the tail pointer are updated to point to the location of the entry in which the new command is stored.

In addition, when another new command is added to the first NAND die queue 13, the controller 10 first stores the command and information (SQ number) for identifying the SQ 51 in which the command was stored, in an empty entry of the command table 17. The controller 10 updates the link pointer of the entry to which the tail pointer points, to the location of the entry in which said another new command is stored. The controller 10 further updates the tail pointer to point to the location of the entry in which said another new command is stored.

As a result, said another new command is added to the entry at the end of the first NAND die queue 13. A command can be added to the first NAND die queue 13 even during the search of the first NAND die queue 13 by the search engine 15.

When a certain command is retrieved from an entry located between the head and the end of the first NAND die queue 13 in order to move the certain command to the second NAND die queue 14, the controller 10 replaces a value of the link pointer of the entry in which one command before the certain command is stored with a value of the link pointer of the entry in which the certain command is stored. For this processing, the search engine 15 stores the location of an entry before one of the entries found (hit) by the search. As a result, the certain command can be retrieved from the entry in a middle of the first NAND die queue 13 even when there is one link pointer (that is, unidirectional linked list) connecting the entries in the command table 17.

When retrieving a command from the entry at the head of the first NAND die queue 13, the controller 10 replaces a value of the head pointer with a value of the link pointer of the entry in which the command to be retrieved is stored. When a command is retrieved from the entry at the end of the first NAND die queue 13, the controller 10 replaces a value of the tail pointer with a value (address) indicating the location of an entry in which one command before the command to be retrieved is stored.

Note that, while the search engine 15 is searching the first NAND die queue 13, it is not possible to retrieve a command from the first NAND die queue 13 being searched.

When implemented as above, the data amount required for one first NAND die queue 13 is, for example, 2+2=4 bytes when each of the head pointer and the tail pointer is 2 bytes (i.e., when the total number of entries in the command table is 65,536 or smaller).

Each of the 512 second NAND die queues 14 can also be implemented with a head pointer indicating the location of the entry in which a command at the head of each second NAND die queue 14 is stored and a tail pointer indicating the location of the entry in which a command at the end is stored.

When a new command is added to the second NAND die queue 14, the controller 10 updates a value of the link pointer of an entry to which the tail pointer points, to point to the location of an entry in which the added command is stored. The controller 10 further updates a value of the tail pointer to point to the location of the entry in which the added command is stored. As a result, a new command is added to the entry at the end of the second NAND die queue 14.

A command is retrieved from an entry only at the head of the second NAND die queue 14. When retrieving a command from the second NAND die queue 14, the controller 10 replaces a value of the head pointer with a value of the link pointer of an entry in which the command to be retrieved is stored. If the second NAND die queue 14 becomes empty due to the retrieval of a command, the controller 10 sets the head pointer and tail pointers to NULL pointers.

When implemented as above, the data amount required for one second NAND die queue 14 is, for example, 2+2=4 bytes when each of the head pointer and the tail pointer is 2 bytes (i.e., when the total number of entries in the command table is 65,536 or smaller).

The first NAND die queue 13 and the second NAND die queue 14 commonly refer to an entry in the command table 17. Each entry of the command table 17 is referred to from either the first NAND die queue 13 or the second NAND die queue 14, or is not referred to from either of the first NAND die queue 13 or the second NAND die queue 14. An entry of the command table 17 is not referred to simultaneously from the first NAND die queue 13 and the second NAND die queue 14.

As described above, the die queue state table 16 records the command presence/absence flag corresponding to each SQ 51, the SQ number being searched, and the command addition flag for each NAND die 21.

The data amount of the die queue state table 16 required for one NAND die 21 is, for example, 1 bit for the command presence/absence flag corresponding to each SQ51 (a total of 256 bits when the number of SQs 51 is 256), the SQ number being searched is 15 bits (the maximum number of the SQs 51 identified by the SQ number is 32767), and when the command addition flag is 1 bit, 256 bits+15 bits+1 bit=272 bits=34 bytes.

Therefore, the data amount required for the first NAND die queue 13, the second NAND die queue 14, and the die queue state table 16 for one NAND die 21 is 4+4+34=42 bytes. Therefore, the data amount required for the queue management of commands for the 512 NAND dies 21 is 42×512=21 Kbytes.

On the other hand, for example, in the third comparative example described with reference to FIGS. 6A to 6D, NAND die queues are provided for each NAND die in the number of SQs. Therefore, when each NAND die queue is configured with 4 bytes of a 2-byte head pointer and a 2-byte tail pointer, the amount of data required for the queue management of commands is 512 (the number of NAND dies)×256 (the number of SQs)×4 bytes=512 Kbytes.

That is, the memory system 1 according to the embodiment in which only a command at the head of each SQ 51 is stored in the second NAND die queue 14 for queue management of each NAND die 21 requires a smaller amount of memory than the memory system according to the comparative example for queue management.

### First Modification Example

When searching a plurality of first NAND die queues 13 by one search engine 15, the search engine 15, for example, starts searching another first NAND die queue 13 after completing a search of all entries in one first NAND D die queue 13. Alternatively, the search engine 15 may suspend the search before the search of all the entries of one first NAND die queue 13 is completed, and may start searching another first NAND die queue 13.

The number of entries in the first NAND die queue 13 targeted by the search engine 15 in one search is determined by the search performance of the search engine 15 and the access time to the NAND die 21. In order to prevent the performance of the memory system 1 from deteriorating, the search of the first NAND die queue 13 must be completed before access to the NAND die 21 is completed and the next command is retrieved from the second NAND die queue 14. Here, the number of entries is synonymous with the number of commands.

When a search of another first NAND die queue 13 is started after the search of all entries is completed, a first NAND die queue 13 that takes a long time to complete the search may affect command processing for the NAND die 21 corresponding to another first NAND die queue 13 that takes a short time to complete the search. On the other hand, by setting an upper limit on the number of entries (or the search time) for a first NAND die queue 13 to be targeted in one search of the search engine 15, the command processing for the NAND die 21 corresponding to another other first NAND die queue 13, which has a short time to complete the search, will not be affected.

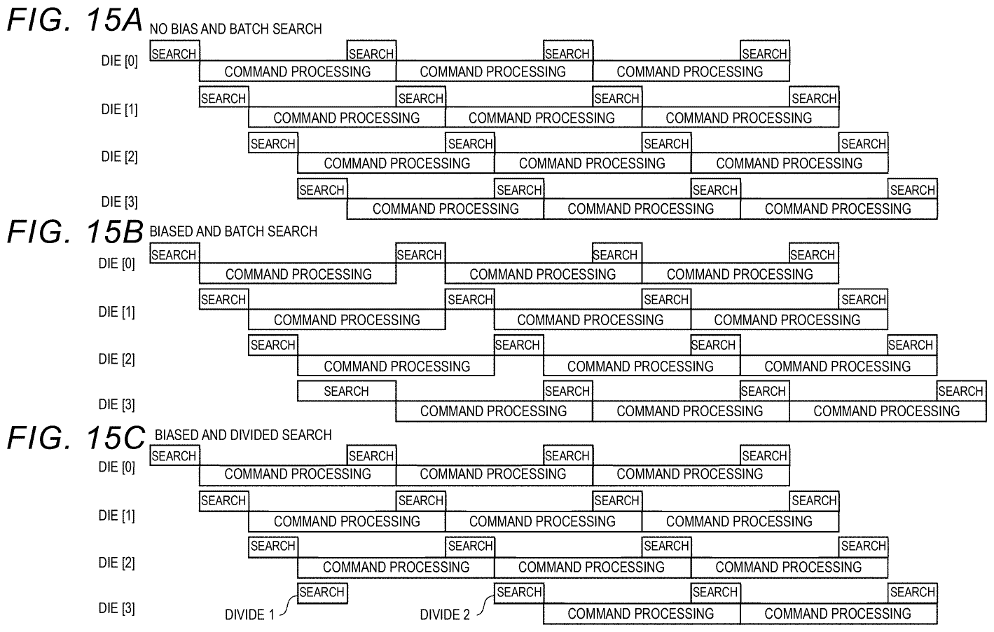

An example of the search of the first NAND die queue 13 in a first modification example will be described with reference to FIGS. 15A to 15C. FIGS. 15A to 15C illustrate an example in which the NAND memory 20 includes four NAND dies 21 (NAND dies [0 to 3]). FIGS. 15A to 15C illustrate a state in which the search engine 15 repeatedly searches the four first NAND die queues 13 in an order of the first NAND die queue [0], the first NAND die queue [1], the first NAND die queue [2], and the first NAND die queue [3]. Here, command processing for each NAND die 21 (that is, retrieving a command from the second NAND die queue 14) is not started until search processing for the first NAND die queue 13 associated with the previous command processing is completed. That is, it is assumed that a mechanism to queue a plurality of search requests for one first NAND die queue 13 is not provided.

FIG. 15A illustrates a case in which the time until all the four first NAND die queues 13 are searched is equal to or shorter than one command processing time. In this case, the command processing for the four NAND dies 21 is executed without any gap.

FIG. 15B illustrates a case in which the search processing time of the first NAND die queue [3] is lengthened and the time until the search of all the four first NAND die queues 13 is completed is longer than the command processing time accordingly. In this case, not only the start of the command processing for the NAND die [3] is delayed, but also the start of the command processing for the other NAND dies [0 to 2] is delayed. That is, in this case, the command processing for the four NAND dies 21 cannot be executed without any gap.

FIG. 15C illustrates an example in which an upper limit is set on the number of entries (or the search time) in the first NAND die queue 13 to be targeted in one search and the search of the first NAND die queue [3] is performed in two parts. The start of command processing for the NAND die [3] is held back until the previous search processing is completed, but this does not affect the start of command processing for the other NAND dies [0-2]. That is, the start of the command processing for the other NAND dies [0-2] is not delayed. In this way, by setting the upper limit on the number of entries to be searched (or the search time) and dividing the search of one first NAND die queue 13, it is possible to prevent the processing performance of the commands of the other NAND dies [0 to 2] from deteriorating while the processing performance of the commands of the NAND die [3] alone is deteriorated.

### Second Modification Example

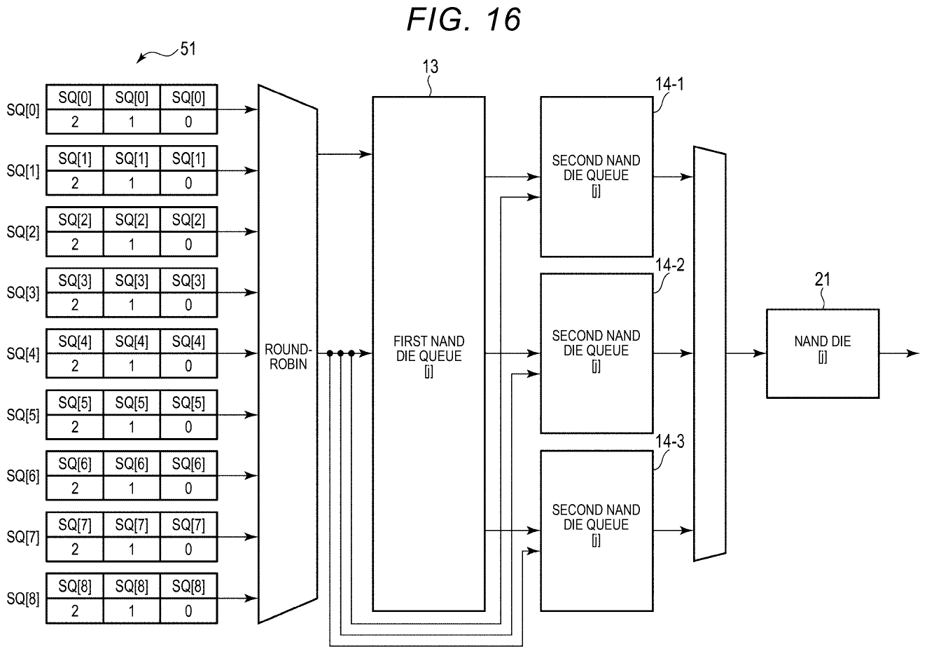

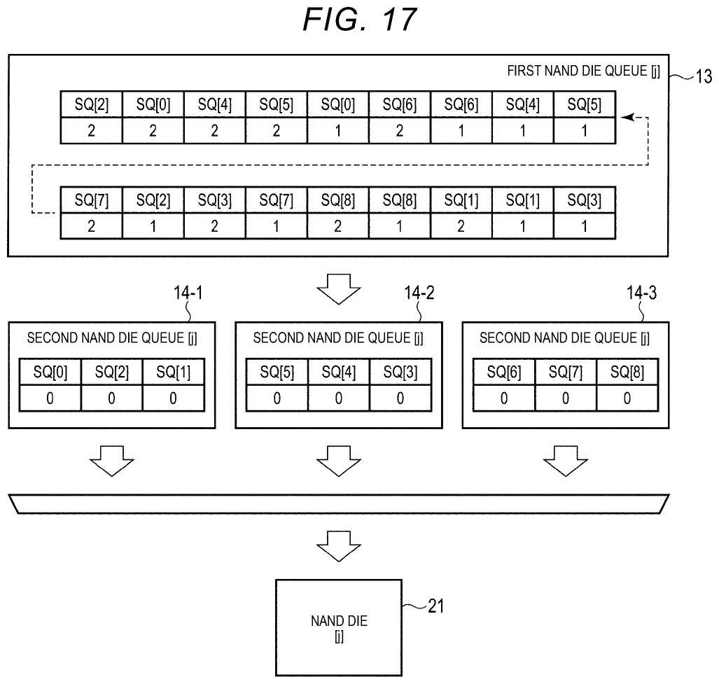

In the above, an example in which one second NAND die queue 14 is provided for each NAND die 21 is described. A memory system 1 according to a second modification example of the embodiment has two or more second NAND die queues 14 for each NAND die 21. FIG. 16 illustrates an example in which one first NAND die queue 13 (first NAND die queue [j]) and three second NAND die queues 14 (second NAND die queues [j] 14-1 to 14-3) are provided for a certain NAND die 21 (NAND die [j]).

FIG. 16 illustrates an example in which the host 2 provides nine SQs [0-8] 51. The second NAND die queue [j] 14-1 is assigned to the SQs [0-2] 51. The second NAND die queue [j] 14-2 is assigned to the SQs [3-5] 51. The second NAND die queue [j] 14-3 is assigned to the SQs [6-8] 51.

The controller 10 determines which of the SQs [0-8] to retrieve a command from, for example, by the round-robin arbitration.

Here, it is assumed that the SQ [1] is determined as a target.

When there is no information recorded in the die queue state table 16 indicating that a command of the SQ [1] is stored in the second NAND die queue 14-1, the controller 10 stores the retrieved command of the SQ [1] in the second NAND die queue [j] 14-1.

When there is information recorded in the die queue state table 16 indicating that a command of the SQ [1] is stored in the second NAND die queue 14-1, the controller 10 stores the retrieved command of the SQ [1] in the first NAND die queue [j].

The controller 10 selects one of the three second NAND die queues [j] 14-1 to 14-3, for example, by the round-robin arbitration, and retrieves a command. The controller 10 controls processing for the NAND die [j] in accordance with the retrieved command.

For example, when a command of the SQ [1] is retrieved from the second NAND die queue [j] 14-1, the controller 10 causes the search engine 15 to search for a command of the SQ [1] from the head of the first NAND die queue [j]. When a command of the SQ [1] is detected, the controller 10 stores the detected command in the second NAND die queue [j] 14-1.

FIG. 17 is a diagram illustrating queue management of commands executed by using three second NAND die queues 14 for one NAND die 21.

For example, it is assumed that the host 2 provides nine SQs 51 (SQs [0-8]), the SQs [0-2] are assigned to the second NAND die queue [j] 14-1, the SQs [3-5] are assigned to the second NAND die queue [j] 14-2, and the SQs [6-8] are assigned to the second NAND die queue [j] 14-3.

The controller 10 determines a second NAND die queue 14 from which to retrieve a command from among the three second NAND die queues [j] 14-1 to 14-3, for example, by the round-robin arbitration.

For example, if the second NAND die queue [j] 14-1 is determined as the second NAND die queue 14 from which to retrieve a command, the controller 10 retrieves a command 0 of the SQ [1] stored at the head of the second NAND die queue [j] 14-1. In response to the command 0 of the SQ [1] being retrieved, the controller 10 searches the first NAND die queue [j] for the next command of the SQ [1], and moves the detected command (command 1) of the SQ [1] to the end of the second NAND die queue [j] 14-1.

When the second NAND die queue [j] 14-2 is determined as the second NAND die queue 14 from which to retrieve a command, the controller 10 retrieves a command 0 of the SQ [3] stored at the head of the second NAND die queue [j] 14-2. In response to the command 0 of the SQ [3] being retrieved, the controller 10 searches the first NAND die queue [j] for the next command of the SQ [3], and moves the detected command (command 1) of the SQ [3] to the end of the second NAND die queue [j] 14-2.

Similarly, when the second NAND die queue [j] 14-3 is determined as the second NAND die queue 14 from which to retrieve a command, the controller 10 retrieves a command 0 of the SQ [8] stored at the head of the second NAND die queue [j] 14-3. In response to the command 0 of the SQ [8] being retrieved, the controller 10 searches the first NAND die queue [j] for the next command of the SQ [8], and moves the detected command (command 1) of the SQ [8] to the end of the second NAND die queue [j] 14-3.

In FIG. 17, the number of SQs 51 assigned to each of the second NAND die queues [j] 14-1 to 14-3 is set to the same number, but by changing the number of SQs 51 assigned among the second NAND die queues [j] 14-1 through 14-3, the frequency at which commands are executed can be changed among the three groups of SQs 51.

For example, by assigning a relatively small number of SQs 51 in which a command requiring high responsiveness is stored to the second NAND die queue [j] 14-1, it is also possible to execute a command of the second NAND die queue [j] 14-1 by overtaking commands previously stored in the other second NAND die queues [j] 14-2 to 14-3.

Alternatively, in the arbitration for selecting the second NAND die queue 14 for retrieving a command from the three second NAND die queues [j] 14-1 to 14-3, the second NAND die queues [j] 14-1 to 14-3 may be selected at frequencies different from each other.

For example, the host 2 may want to change the execution frequency of commands stored in each SQ 51 depending on the data transfer bandwidth and command response time required by each application. The memory system 1 according to the second modification example of the embodiment can respond to such a request from the host 2 by providing a plurality of second NAND die queues 14 for one NAND die 21.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a non-volatile memory including at least one memory die; and
a controller including a first command queue corresponding to the at least one memory die and a second command queue corresponding to the at least one memory die, the controller being operatively coupled to the non-volatile memory and to a host that includes a plurality of submission queues, each of the plurality of submission queues configured to store a plurality of commands, wherein
the controller is configured to:
retrieve a first command from a first submission queue of the plurality of submission queues;
determine whether a second command retrieved from the first submission queue before the first command is retrieved is stored in the second command queue;
when the second command is stored in the second command queue, store the first command retrieved from the first submission queue in the first command queue; and
when the second command is not stored in the second command queue, store the first command retrieved from the first submission queue in the second command queue.

2. The memory system according to claim 1, wherein the controller is further configured to control access to the at least one memory die based on the first command retrieved from the second command queue.

3. The memory system according to claim 1, wherein
the at least one memory die includes a plurality of memory dies, and
the controller is further configured to, for each of the plurality of memory dies:
retrieve a third command from each of the plurality of submission queues;
determine whether a fourth command retrieved from each of the plurality of submission queues before the third command is retrieved is stored in the second command queue;
when the fourth command is stored in the second command queue, store the third command retrieved from each of the plurality of submission queues in the first command queue; and
when the fourth command is not stored in the second command queue, store the third command retrieved from each of the plurality of submission queues in the second command queue.

4. The memory system according to claim 1, wherein
the controller is further configured to:
search the first command queue for a fifth command retrieved from the first submission queue after the first command is retrieved, in response to the first command being retrieved from the second command queue; and
when the fifth command is detected in the first command queue, retrieve the fifth command from the first command queue and store the fifth command in the second command queue.

5. The memory system according to claim 4, wherein
the controller is further configured to:
determine whether the search of the fifth command is in progress, in response to a sixth command being retrieved from the first submission queue; and
when the search of the fifth command is in progress, store the sixth command in the first command queue.

6. The memory system according to claim 4, wherein
the controller is further configured to:
manage first information indicating whether a command retrieved from the first submission queue is stored in at least one of the first command queue or the second command queue;
set the first information to indicate that the command retrieved from the first submission queue is stored in at least one of the first command queue or the second command queue, in response to the fifth command being detected in the first command queue; and
set the first information to indicate that the command retrieved from the first submission queue is not stored in either the first command queue or the second command queue, in response to the fifth command not being detected in the first command queue.

7. The memory system according to claim 6, wherein
the controller is further configured to set the first information to indicate that the command retrieved from the first submission queue is stored in at least one of the first command queue or the second command queue, in response to the first command being stored in the second command queue.

8. The memory system according to claim 4, wherein
the controller is further configured to:
manage second information indicating whether the first command queue is being searched for the fifth command; and
when searching the first command queue to detect the fifth command, set the second information to indicate that the search of the fifth command is in progress.

9. The memory system according to claim 4, wherein
the controller includes a plurality of the first command queues each corresponding to the at least one memory die, each of the plurality of first command queues including a first number of entries, and
the controller is further configured to, in searching for a command stored in each of the plurality of first command queues, search for the command from a second number of the entries less than the first number of the entries for one of the plurality of first command queues, and start searching for the command for the other one of the plurality of first command queues.

10. The memory system according to claim 1, wherein
the plurality of submission queues: further include a second submission queue,
the controller includes a plurality of the second command queues each corresponding to the at least one memory die, the plurality of second command queues including at least a third command queue and a fourth command queue, and
the controller is further configured to:
retrieve a seventh command from the first submission queue;
store the seventh command retrieved from the first submission queue in the third command queue;
retrieve an eighth command from the first submission queue;
store the eighth command retrieved from the first submission queue in the first command queue;
retrieve the eighth command from the first command queue and store the eighth command in the third command queue, in response to the seventh command being retrieved from the third command queue;
retrieve a ninth command from the second submission queue;
store the ninth command retrieved from the second submission queue in the fourth command queue;
retrieve a tenth command from the second submission queue;
store the tenth command retrieved from the second submission queue in the first command queue; and
retrieve the tenth command from the first command queue and store the tenth command in the fourth command queue, in response to the ninth command being retrieved from the fourth command queue.

11. A method of controlling a non-volatile memory that includes at least one memory die, comprising:
managing a first command queue corresponding to the at least one memory die and a second command queue corresponding to the at least one memory die;
communicating with a host that includes a plurality of submission queues, each of the plurality of submission queues configured to store a plurality of commands;
retrieving a first command from a first submission queue of the plurality of submission queues;
determining whether a second command retrieved from the first submission queue before the first command is retrieved is stored in the second command queue;
when the second command is stored in the second command queue, storing the first command retrieved from the first submission queue in the first command queue; and
when the second command is not stored in the second command queue, storing the first command retrieved from the first submission queue in the second command queue.

12. The method according to claim 11, further comprising:
allowing access to the at least one memory die based on the first command retrieved from the second command queue.

13. The method according to claim 11, wherein
the at least one memory die includes a plurality of memory dies, and the method further comprises, for each of the plurality of memory dies:
retrieving a third command from each of the plurality of submission queues;
determining whether a fourth command retrieved from each of the plurality of submission queues before the third command is retrieved is stored in the second command queue;
when the fourth command is stored in the second command queue, storing the third command retrieved from each of the plurality of submission queues in the first command queue; and
when the fourth command is not stored in the second command queue, storing the third command retrieved from each of the plurality of submission queues in the second command queue.

14. The method according to claim 11, further comprising:
searching the first command queue to detect a fifth command retrieved from the first submission queue after the first command is retrieved, in response to the first command being retrieved from the second command queue; and
when the fifth command is detected from the first command queue, retrieving the fifth command from the first command queue and storing the fifth command in the second command queue.

15. The method according to claim 14, further comprising:
determining whether the search of the fifth command is in progress, in response to a sixth command being retrieved from the first submission queue; and
when the search of the fifth command is in progress, storing the sixth command in the first command queue.

16. The method according to claim 14, further comprising:
managing first information indicating whether a command retrieved from the first submission queue is stored in at least one of the first command queue or the second command queue;
setting the first information to indicate that the command retrieved from the first submission queue is stored in at least one of the first command queue or the second command queue, in response to the fifth command being detected in the first command queue; and
setting the first information to indicate that the command retrieved from the first submission queue is not stored in either the first command queue or the second command queue, in response to the fifth command not being detected in the first command queue.

17. The method according to claim 16, further comprising:
setting the first information to indicate that the command retrieved from the first submission queue is stored in at least one of the first command queue or the second command queue, in response to the first command being stored in the second command queue.

18. The method according to claim 14, further comprising:
managing second information indicating whether the first command queue is being searched to detect the fifth command; and
when searching the first command queue to detect the fifth command, set the second information to indicate that the search of the fifth command is in progress.

19. The method according to claim 14, further comprising:
managing a plurality of the first command queues each corresponding to the at least one memory die, each of the plurality of first command queues including a first number of entries; and
in searching for a command stored in each of the plurality of first command queues, searching for the command from a second number of the entries less than the first number of the entries for one of the plurality of first command queues, and starting searching for the command for the other one of the plurality of first command queues.

20. The method according to claim 11, wherein
the plurality of submission queues: further include a second submission queue, and the method further comprises:
managing a plurality of the second command queues each corresponding to the at least one memory die, the plurality of second command queues including at least a third command queue and a fourth command queue;
retrieving a seventh command from the first submission queue;
storing the seventh command retrieved from the first submission queue in the third command queue;
retrieving an eighth command from the first submission queue;
storing the eighth command retrieved from the first submission queue in the first command queue;
retrieving the eighth command from the first command queue and storing the eighth command in the third command queue, in response to the seventh command being retrieved from the third command queue;
retrieving a ninth command from the second submission queue;
storing the ninth command retrieved from the second submission queue in the fourth command queue;
retrieving a tenth command from the second submission queue;
storing the tenth command retrieved from the second submission queue in the first command queue; and
retrieving the tenth command from the first command queue and storing the tenth command in the fourth command queue, in response to the ninth command being retrieved from the fourth command queue.
